(19) United States
(12) Patent Application Publication
(10) Pub. No.: US 2005/0237417 A1
(43) Pub. Date: Oct. 27, 2005

(54) Camera, interchangeable lens, intermediate adapter, and camera system including same

(76) Inventor: Tetsuo Miyasaka, Kamiina-gun (JP)

Correspondence Address: STRAUB & POKOTYLO, 620 TINTON AVENUE, BLDG. B, 2ND FLOOR, TINTON FALLS, NJ, 07724, US

(21) Appl. No.: 11/158,815

(22) Filed: Jun. 22, 2005

Related U.S. Application Data
(63) Continuation of application No. PCT/JP04/11094, filed on Aug. 3, 2004.

(30) Foreign Application Priority Data
Aug. 12, 2003 (JP) 2003-292267

(51) Int. Cl. H04N 5/225

(52) U.S. Cl. 348/335

(57) ABSTRACT

A camera system comprising a camera body and an interchangeable lens detachably set to the camera body, includes a distance measuring part configured to measure a focusing error of the interchangeable lens through detecting a flux of light passed through the interchangeable lens, an intermediate adapter arranged for detachably being set between the camera body and the interchangeable lens, a data storing part configured to store first data and second data, a reading part configured to read the first data and the second data from the data storing part, and a correcting part configured to correct the detection result of focusing error received from the distance measuring part by using the first data when the intermediate adapter is not set, and correct the detection result of focusing error received from the distance measuring part by using the second data when the intermediate adapter is set.

### CROSS-REFERENCE TO RELATED APPLICATIONS

This is a Continuation Application of PCT Application No. PCT/JP2004/011094, filed Aug. 3, 2004, which was published under PCT Article 21(2) in Japanese.

This application is based upon and claims the benefit of priority from prior Japanese Patent Application No. 2003-292267, filed Aug. 12, 2003, the entire contents of which are incorporated herein by reference.

### BACKGROUND OF THE INVENTION

1. Field of the Invention

The present invention relates to a technology of correcting the AF action of a camera in response to a degree of spherical aberration of a camera lens, and particularly to a camera equipped with an AF sensing unit, an interchangeable lens, an intermediate adapter, and a camera system including the same.

2. Description of the Related Art

It happens that a camera equipped with a TTL phase difference type AF sensing unit yields out-of-focus images when shooting at full open aperture in spite of the lens being adjustably focused on the basis of focusing data detected by the AF sensing unit. This results from a difference in the spherical aberration of the camera lens between a F-number of full-open aperture and a F-number of AF sensing aperture for measuring the focal point, which thus dislocates the best imaging plane.

Disclosed in Jpn. Pat. Appln. KOKAI Publication No. 59-208514 is a technique of correcting the output of the AF sensing unit with displacement correcting data of the best imaging plane (referred to as “AF correcting data” hereinafter) which has been decided from a difference in the spherical aberration between two F-numbers and stored in the camera lens.

A lens interchangeable camera has an intermediate adapter provided between the camera and the interchangeable lens for modifying the focal length. The intermediate adapter may be known as a telescopic converter for lengthening the focal length. When mounted on the camera, the spherical aberration of the intermediate adapter as well as the spherical aberration of the camera lens has to be concerned for affecting the focal length.

Disclosed in Jpn. Pat. Appln. KOKAI Publication No. 4-93824 is a technique of correcting the output of the AF sensing unit through using a combination of the two AF correcting data stored in the interchangeable lens and the intermediate adapter respectively.

### BRIEF SUMMARY OF THE INVENTION

A camera system according to an aspect of the present invention includes: a distance measuring part configured to measure a focusing error of the interchangeable lens through detecting a flux of light passed through the interchangeable lens; a first intermediate adapter and a second intermediate adapter arranged for detachably being set between the camera body and the interchangeable lens; a first storing part configured to store first data decided by the optical characteristics of the interchangeable lens and second data decided by the optical characteristics of a combination of the interchangeable lens and the first intermediate adapter; a second storing part configured to store third data to correct the second data; and a correcting part configured to correct the output received from the distance measuring part by using the first data when neither the first nor second intermediate adapters is set, correct the output received from the distance measuring part by using the second data when the first intermediate adapter is set, and correct the output received from the distance measuring part by using both the second and third data when the second intermediate adapter is set.

### BRIEF DESCRIPTION OF THE SEVERAL VIEWS OF THE DRAWING

FIG. 1 is a block diagram showing an arrangement of a camera system.

FIG. 2 is a view showing a first variation of the camera system according to the invention.

FIG. 3 is a view showing a second variation of the camera system according to the invention.

FIG. 4 is a view showing a third variation of the camera system according to the invention.

FIG. 5 is a flowchart schematically showing a procedure of the camera CPU receiving the lens information.

FIG. 6 is a flowchart schematically showing a procedure of the camera CPU calculating a focusing error correcting data for correct focusing.

### DETAILED DESCRIPTION OF THE INVENTION

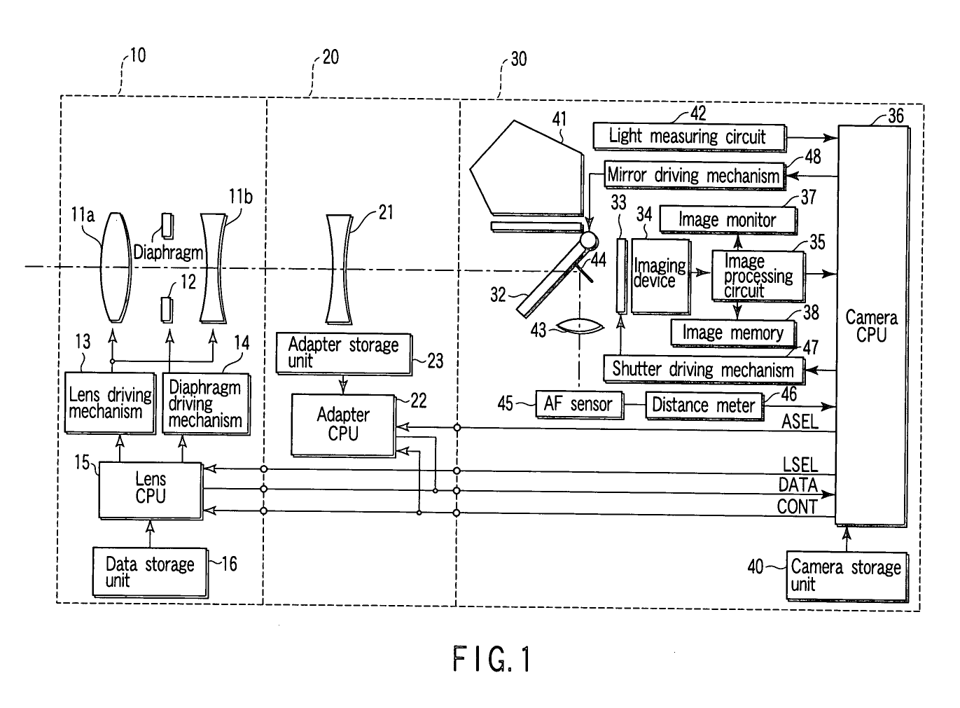

FIG. 1 is a block diagram showing a typical arrangement of a camera system.

The camera system consists mainly of an interchangeable lens 10, an intermediate adapter 20, and a camera body unit 30. The interchangeable lens 10, the intermediate adapter 20, and the camera body unit 30 are detachably joined together by mounting fittings (not shown).

The interchangeable lens 10 includes camera lenses 11a and 11b, a diaphragm 12, a lens driving mechanism 13, a diaphragm driving mechanism 14, a lens CPU 15, and a data storage unit 16.

The lens CPU 15 is provided for exclusively controlling the action of the interchangeable lens 10. More particularly, its control signal is received by the lens driving mechanism 13 which in turn drives the camera lenses 11a and 11b forward and backward for focusing. The control signal is also received by the diaphragm driving mechanism 14 which in turn drives the diaphragm 12 for exposure control. Moreover, the lens CPU 15 exchanges signals of various information with the camera body unit 30.

The data storage unit 16 is provided for storage of specific information about the lens unit.

The intermediate adapter 20 includes a telescopic lens 21, an adapter CPU 22, and an adapter storage unit 23.

The telescopic lens 21 is provided for varying the focal length of the interchangeable lens 10. The magnification of the lens can thus be increased, for example, two times by the movement of the telescopic lens 21.

The adapter storage unit 23 is provided for storage of specific information about the intermediate adapter (for example, the type of lens or the AF correcting data). The adapter CPU 22 is provided for exchanging signals with the camera body unit 30 to transmit specific information about the intermediate adapter for AF correcting action.

The camera body unit 30 consists mainly of a quick return mirror 32, a shutter 33, an imaging device 34, an image processing circuit 35, a camera CPU 36, an image monitor 37, an image memory 38, a camera storage unit 40, a pentagonal prism 41, a light measuring circuit 42, an AF lens 43, a sub mirror 44, an AF sensor 45, a distance meter 46, a shutter driving mechanism 47, and a mirror driving mechanism 48.

The quick return mirror 32 has a half mirror provided at the center thereof for transmitting an optical image of the object to the pentagonal prism 41 and the AF sensor 45 in a non-shooting mode. The imaging device 34 converts the optical image of the object into an electric signal of image data using, for example, CCD. The camera CPU 36 is provided for exclusively controlling the action of the camera system and subjecting the image data to a variety of processing actions by controlling the image processing circuit 35. A group of data required for operating the camera CPU 36 is stored in the camera storage unit 40.

The camera CPU 36 also communicates with the lens CPU 15 in the interchangeable lens 10 and the adapter CPU 22 in the intermediate adapter 20 for receiving the characteristic information of the camera lenses 11a and 11b and the AF correcting information respectively.

There are provided four signal lines ASEL, LSEL, DATA, and CONT for exchanging the information. The signal line ASEL is provided for selectively supplying the intermediate adapter 20 with its desired information. The signal line LSEL is provided for selectively supplying the interchangeable lens 10 with its desired information. The signal line DATA is a common line for supplying the CPUs with the lens characteristic information. The signal line CONT is provided for supplying the CPUs with control signals (for example, a demand for lens information or a command for diaphragm driving) from the camera CPU.

The image monitor 37 may be a liquid crystal display monitor or the like and is provided for displaying an image data. The image memory 38 is provided in the form of a recording medium, such as Smart Media (registered trademark), in which the image data is recorded.

The light measuring circuit 42 is provided for receiving with its optoelectric converter element (not shown) a reflection of the optical image from the pentagonal prism 41 to measure the brightness of the object to be imaged. The camera CPU 36 calculates exposure conditions from the measurement of the brightness. The AF sensor 45 is provided for receiving the optical image of the object divided in two by the sub mirror 44 and passed through the AF lens 43. The distance meter 46 is provided for calculating from an output of the AF sensor 45 the movement of the lens for correct focusing. The AF distance meter is of so-called TTL phase difference type in which the flux of light used for measuring the focal point is equivalent to the one with the camera lens aperture stopped down to F8.

Then, the action of the camera system will be described.

The action starts with a photographer pressing down the release button (not shown) on the camera body unit 30 to its first position. The camera CPU 36 then calculates the aperture value for an appropriate exposure from brightness of a object to be shot measured by the light measuring circuit 42, and the result is received by the lens CPU 15. The lens CPU 15 provides the diaphragm driving mechanism 14 with its output signal for obtaining a desired size of the aperture.

Also, the camera CPU 36 calculates from the measurement of the distance meter 46, the lens information from the interchangeable lens 10, and the lens information from the intermediate adapter 20 the movement of the camera lenses 11a and 11b which is then received by the lens CPU 15 for correct focusing. In response to the movement data, the lens CPU 15 provides the lens driving mechanism 13 with a control signal for moving the camera lenses 11a and 11b to their correct focusing positions.

When the photographer presses down the release button (not shown) on the camera body unit 30 to its second position, the camera CPU 36 retracts the quick return mirror 32 from the optical path of the camera and actuates the shutter 33 for directing the optical image of the object to the imaging device 34 and subjects the image data output of the imaging device 34 to relevant image processing actions. The image processing actions of the camera CPU 36 including color correction are carried out based on the lens information from the interchangeable lens 10 and the lens information from the intermediate adapter 20.

The camera system of the present invention including the interchangeable lens 10, the intermediate adapter 20, and the camera body unit 30 shown in FIG. 1 is arranged operable in three different variations described below.

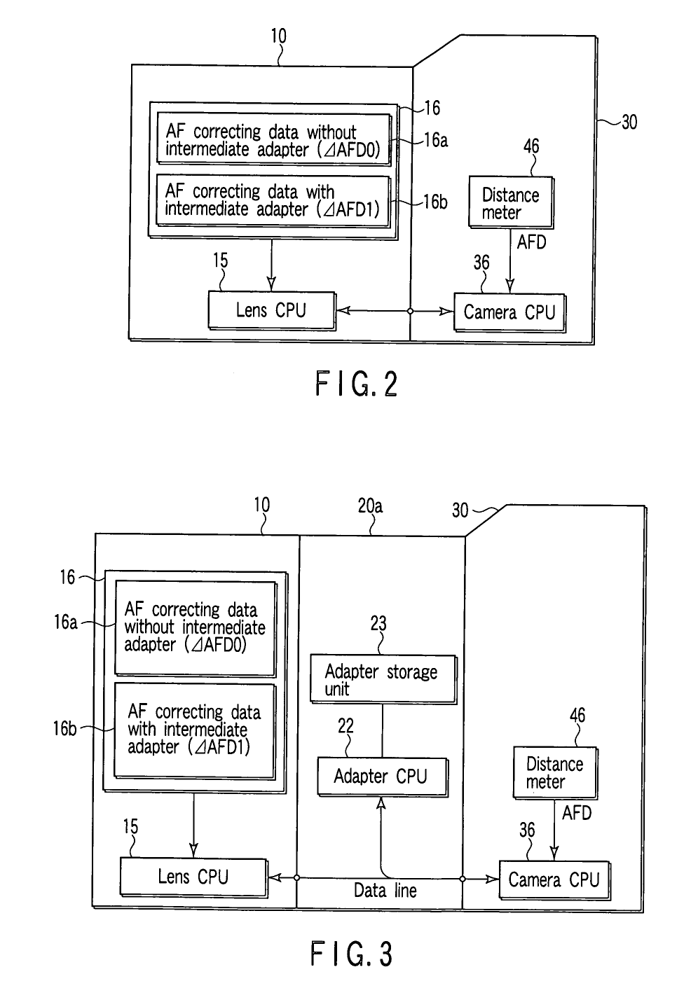

FIG. 2 illustrates the first variation of the camera system of the present invention. The first variation of the camera system employs the interchangeable lens 10 and the camera body unit 30.

In the data storage unit 16, the AF correcting data is saved as a combination of a first AF correcting data 16a (ΔAFD0) without the intermediate adapter 20 and a second AF correcting data 16b (ΔAFD1) with the intermediate adapter 20.

Accordingly, as the camera CPU 36 corrects the measurement of focusing error (AFD) of the distance meter 46 calculated by TTL phase difference technique with the AF correcting data, the movement amount of the camera lens for correct focusing is transmitted to the lens CPU 15.

FIG. 3 illustrates the second variation of the camera system of the present invention. The second variation of the camera system employs the interchange-able lens 10, a type A intermediate adapter 20 (a first intermediate adapter) 20a, and the camera body unit 30. The type A intermediate adapter 20a means an initial version of the intermediate adapter.

In the data storage unit 16, the AF correcting data is saved as a combination of an AF correcting data 16a (ΔAFD0) without the intermediate adapter 20 and an AF correcting data 16b (ΔAFD1) with the type A intermediate adapter 20a. The type A intermediate adapter 20a includes an adapter CPU 22a and an adapter storage unit 23a. The adapter storage unit 23a holds a specific information about the intermediate adapter 20a but not the AF correcting data.

Accordingly, as the camera CPU 36 corrects the measurement of focusing error (AFD) of the distance meter 46 calculated by TTL phase difference technique with the AF correcting data, the movement amount of the camera lens for correct focusing is transmitted to the lens CPU 15.

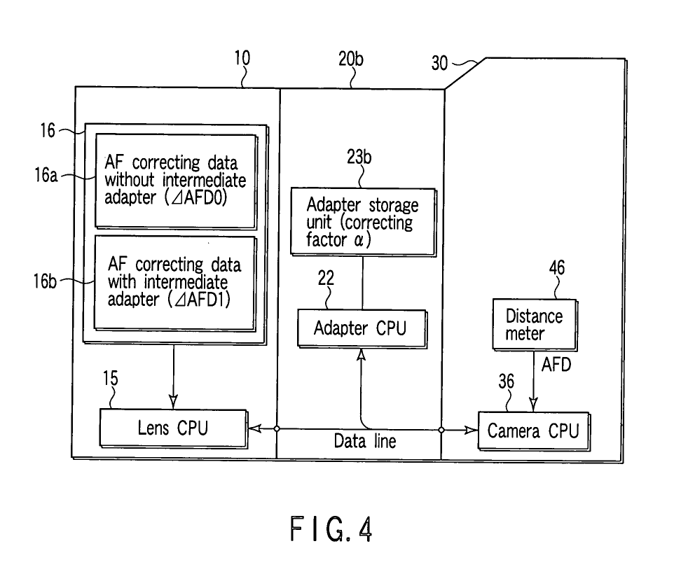

FIG. 4 illustrates a third variation of the camera system of the present invention. The third variation of the camera system employs the interchangeable lens 10, a type B intermediate adapter (a second intermediate adapter) 20b, and the camera body unit 30. The type B intermediate adapter 20b means an improved version of the type A intermediate adapter 20a.

In the data storage unit 16, the AF correcting data is saved as a combination of an AF correcting data 16a (ΔAFD0) without the intermediate adapter 20 and an AF correcting data 16b (ΔAFD1) with the type A intermediate adapter 20a. The type B intermediate adapter 20b includes an adapter CPU 22b and an adapter storage unit 23b. The adapter storage unit 23b holds a correction factor α or third data used for converting the AF correction data for the type A intermediate adapter 20a into an AF correction data for the type B intermediate adapter 20b.

Accordingly, as the camera CPU 36 corrects the measurement of focusing error (AFD) of the distance meter 46 calculated by TTL phase difference technique with the AF correcting data, the movement amount of the camera lens for correct focusing is transmitted to the lens CPU 15.

The action of the camera system for AF correction has mainly two steps:
(1) the camera CPU 36 in the camera body unit 30 receiving the lens information from both the inter-changeable lens 10 and the intermediate adapter 20; and
(2) the camera CPU 36 in the camera body unit 30 calculating the movement of the lenses for correct focusing.

The two steps will now be described in more detail. The camera CPU 36 is designed for functioning with the three different variations of the camera system.

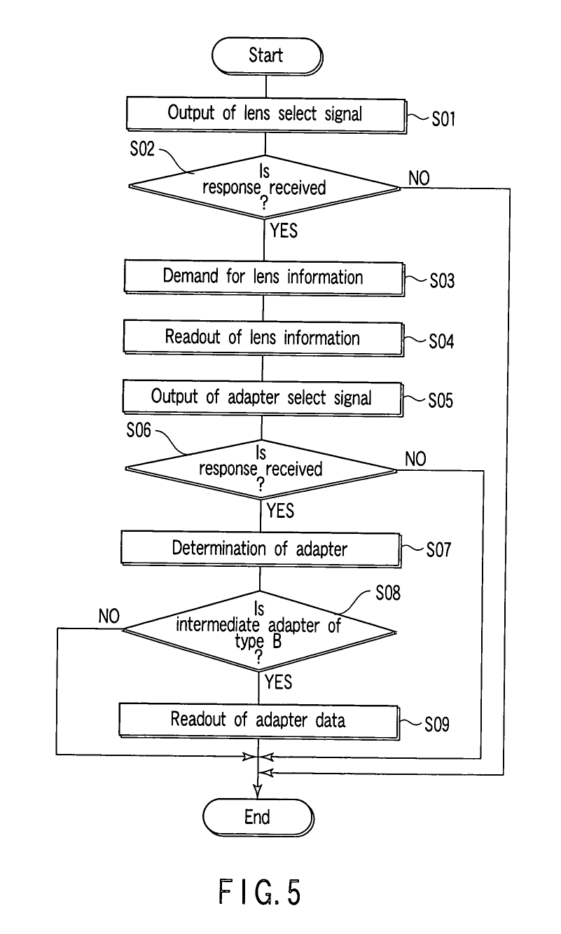

FIG. 5 is a flowchart schematically showing a procedure of the camera CPU 36 receiving the lens information. The procedure starts when the camera body unit 30 is switched on or set to the interchangeable lens 10 and the intermediate adapter 20.

In step S01, the camera CPU 36 dispatches a lens select signal for receiving the lens information from the interchangeable lens 10. More particularly, the signal line LSEL is turned from a low level to a high level. It is then examined in step S02 whether or not a response is received from the interchangeable lens 10. When the signal line is conducted, the lens CPU 15 releases a response signal indicating that the interchangeable lens 10 is ready for starting the communication.

When it is determined “no” in step S02, i.e., no response is received from the interchangeable lens 10, the camera CPU 36 ends the action.

When it is determined “yes” in step S02, i.e., a response is received from the interchangeable lens 10, the action advances to Step S03 where the camera CPU 36 demands to receive the lens information. More specifically, the signal line CONT is conducted for transmitting a lens information demand signal. Upon receiving the demand signal, the lens CPU 15 retrieves the lens information from the data storage unit 16 and transmits the same to the camera CPU.

The lens information to be transmitted may include the type of lens, the F-number at full opening, and the AF correcting data (ΔAFD0 and ΔAFD1). In step S04, the lens information is received by the camera CPU 36 and saved in the camera storage unit 40.

This is followed by Step S05 where an adapter select signal for receiving the adapter information from the intermediate adapter 20 is dispatched from the camera CPU 36. More particularly, the signal line ASEL is turned from a low level to a high level. It is examined in step S06 whether or not a response is received from the intermediate adapter 20. When the signal line is conducted, the adapter CPU 22 releases a response signal indicating that the intermediate adapter 20 is ready for starting the communication.

When it is determined “no” in step S06, i.e., no response is received from the intermediate adapter 20, the camera CPU 36 ends the action of the camera system having an arrangement shown in FIG. 2.

When it is determined “yes” in step S06, i.e., a response is received from the intermediate adapter 20, the action advances to Step S07 where the camera CPU 36 checks the response to identify the type of the intermediate adapter. In other words, the camera CPU 36 examines whether or not the intermediate adapter is of the type B.

When it is determined “no” in step S08, i.e., the intermediate adapter is of not the type B but the type A such as shown in FIG. 3, the camera CPU 36 ends the action as having received the lens correction data (ΔAFD1).

When it is determined “yes” in step S08, i.e., the intermediate adapter is of the type B such as shown in FIG. 4, the camera CPU 36 demands to receive the adapter information. More specifically, the signal line CONT is conducted for transmitting an adapter data demand signal. Upon receiving the demand signal, the adapter CPU 22b retrieves the adapter information from the adapter storage unit 23b and transmits the same to the camera CPU 36.

The adapter data may to be transmitted include the correction factor α. In step S09, the adapter data is received by the camera CPU 36 and saved in the camera storage unit 40.

Through conducting the above described procedure, the camera CPU 36 can receive and save the AF correct-ing data corresponding to each variation of the camera system arrangement in the camera storage unit 40.

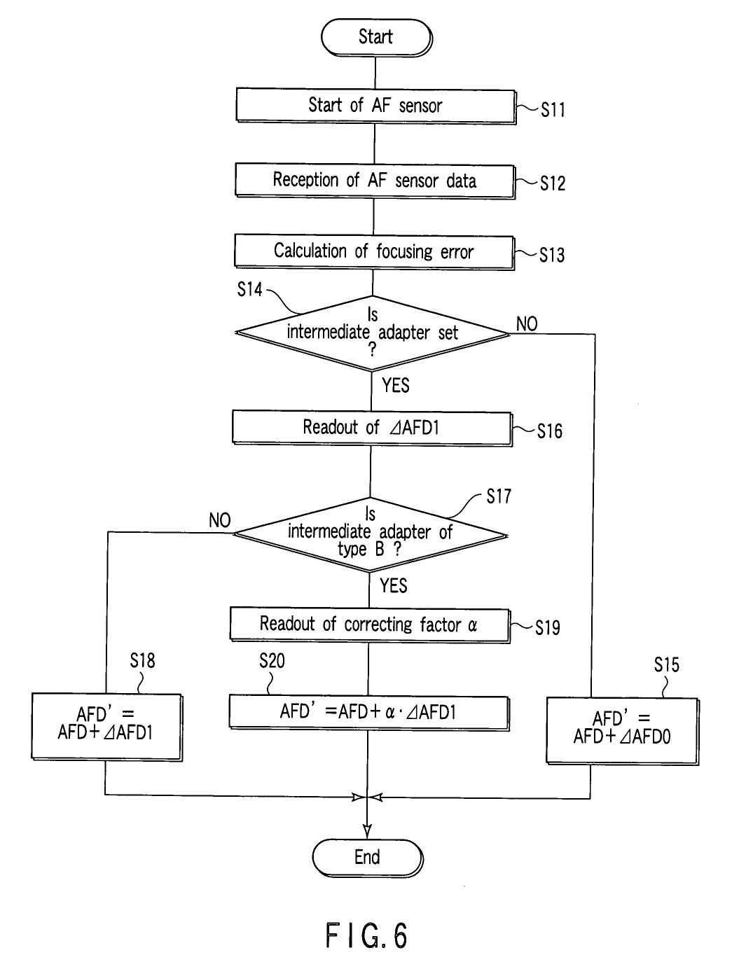

FIG. 6 is a flowchart schematically showing a procedure of the camera CPU 36 calculating the focusing error for correct focusing. The procedure involves steps of the AF controlling action initiated prior to shooting action by the photographer pressing down the release button (not shown) on the camera body unit 30.

In step S11, the camera CPU 36 dispatches a command for starting the action of the AF sensor 45. In step S12, a measurement of focusing error (the number of pitches across the sensor surface) is received from the AF sensor 45. In step S13, the distance meter 46 calculates the focusing error (AFD) of the camera lenses 11a and 11b from the measurement of the number of pitches.

This is followed by step S14 where the camera CPU 36 examines whether the intermediate adapter 20 is set or not.

When it is determined “no” in step S14, i.e., the intermediate adapter 20 is not set in the camera system shown in FIG. 2, the procedure goes to step S15 where the camera CPU 36 adds the measurement of focusing error (AFD) from the distance meter 46 with the AF correcting data (ΔAFD0) 16a to obtain a focusing error (AFD′) at no presence of the intermediate adapter 20.

When it is determined “yes” in step S14, i.e., the intermediate adapter 20 is set, the procedure goes to Step S16 where the camera CPU 36 retrieves the AF correcting data (ΔAFD1) 16b at the presence of the intermediate adapter 20 from the camera storage unit 40.

In step S17, the camera CPU 36 accesses the camera storage unit 40 and examines whether the intermediate adapter is of the type B or not.

When it is determined “no” in step S17, i.e., the intermediate adapter is of not the type B but the type A and the camera system is as shown in FIG. 3 where the camera CPU 36 has received the AF correcting data (ΔAFD1) 16b, the procedure goes to Step S18. In step S18, the camera CPU 36 adds the measurement of focusing error (AFD) from the distance meter 46 with the AF correcting data (ΔAFD1) 16b to obtain a focusing error (AFD′) at the presence of the intermediate adapter 20.

When it is determined “yes” in step S17, i.e., the intermediate adapter is of the type B and the camera system is as shown in FIG. 4, the procedure goes to Step S19. In step S19, the camera CPU 36 retrieves the correcting factor α from the camera storage unit 40. This is followed by Step S20 where the camera CPU 36 adds the measurement of focusing error (AFD) from the distance meter 46 with a multiplication of the AF correcting data (ΔAFD1) 16b by the correcting factor α to obtain a focusing error (AFD′) at the presence of the intermediate adapter 20.

Finally, the corrected focusing error (AFD′) is transmitted from the camera CPU 36 to the lens CPU 15 where it is used for driving the camera lenses 11a and 11b to focus correctly.

The calculation of the corrected focusing error (AFD′) in step S20 is not limited to the multiplication of the AF correcting data (ΔAFD1) 16b by the correcting factor α but may involve addition (or subtraction) of the AF correcting data (ΔAFD1) 16b with the correcting factor α or use a function in which the AF correcting data (ΔAFD1) 16b and the correcting factor α are parameters.

It is also possible for the camera CPU 36 to receive the AF correcting data (ΔAFD1) 16b and the correcting factor α to be used for AF correcting action not from the interchangeable lens 10 and the intermediate adapter 20 respectively but from any appropriate external peripheral (for example, a server) over a communicating means.

While the foregoing embodiment includes different stages of the present invention, it is understood that various modifications are made by different combinations of the stages or disclosed members of the embodiment. For example, even if some members of the embodiment are deleted, the remaining members can overcome the drawbacks described in the paragraph of problems that the invention is to solve and provide the advantages described in the paragraph of the advantages of the invention, thus remaining in the scope of the present invention.

1. A camera system comprising a camera body and an interchangeable lens detachably set to the camera body, the camera system comprising:
a TTL phase difference type AF apparatus which is installed in the camera body and which detects a focusing error of the interchangeable lens;
a first intermediate adapter detachably set between the camera body and the interchangeable lens in order to modify the optical characteristics of the interchangeable lens;
a data storage unit which is installed in the interchangeable lens and which stores first data and second data; and
a camera CPU installed in the camera body, the camera CPU correcting the detection result of focusing error received from the TTL phase difference type AF apparatus by using the first data when the first intermediate adapter is not set, and correcting the detection result of focusing error received from the TTL phase difference type AF apparatus by using the second data when the first intermediate adapter is set.

2. A camera system according to claim 1, wherein
the first data depends on the optical characteristics of only the interchangeable lens, and
the second data depends on the optical characteristics of a combination of the interchangeable lens and the first intermediate adapter.

3. A camera system according to claim 1, wherein
the camera CPU has a function of determining whether the first intermediate adapter is set or not.

4. A camera system according to claim 1, wherein
the first intermediate adapter includes a first adapter CPU, the first adapter CPU being arranged to communicate with the camera CPU.

5. A camera system according to claim 4, wherein
the camera CPU determines that the first intermediate adapter is set when its communication with the first adapter CPU is enabled.

6. A camera system according to claim 1, wherein
the camera CPU corrects with the first or second data a difference between the optimum focal point corresponding to the F-number of full open aperture of the interchangeable lens and the optimum focal point corresponding to a F-number of AF sensing aperture of the TTL phase difference type AF apparatus.

7. A camera system according to claim 1, wherein a second intermediate adapter which is different from the first intermediate adapter is arranged detachably to be set between the camera body and the interchangeable lens, and the second intermediate adapter is provided for saving third data used for correcting the second data.

8. A camera system according to claim 7, wherein
the camera CPU
corrects the detection result of focusing error received from the TTL phase difference type AF apparatus by using the first data when neither the first nor second intermediate adapters is set;
corrects the detection result of focusing error received from the TTL phase difference type AF apparatus by using the second data when the first intermediate adapter is set; and
corrects the detection result of focusing error received from the TTL phase difference type AF apparatus by using both the second and third data when the second intermediate adapter is set.

9. A camera system according to claim 7, wherein
the first and second intermediate adapters are conversion lenses which change the focal length of the interchangeable lens.

10. A camera system according to claim 7, wherein
the second intermediate adapter includes a second adapter CPU, the second adapter CPU being arranged to communicate with the camera CPU.

11. A second intermediate adapter which is applicable to the camera system according to claim 1, and replaces the first intermediate adapter, wherein
the second intermediate adapter has a function of transmitting the third data to correct the second data to the camera CPU.

12. A second intermediate adapter according to claim 11, having:
an adapter storage unit which stores the third data; and
an adapter CPU arranged for communication with the camera CPU.

13. A camera system comprising a camera body and an interchangeable lens detachably set to the camera body, the camera system comprising:
a TTL phase difference type AF apparatus which is installed in the camera body and which detects a focusing error of the interchangeable lens;
a first intermediate adapter or a second intermediate adapter detachably set between the camera body and the interchangeable lens in order to modify the optical characteristics of the interchangeable lens;
a first storage unit which is installed in the interchangeable lens and which stores first data decided by the optical characteristics of the interchangeable lens and second data decided by the optical characteristics of a combination of the interchangeable lens and the first intermediate adapter;
a second storage unit which is installed in the second intermediate adapter and which stores third data to correct the second data; and
a camera CPU installed in the camera body, the camera CPU correcting the detection result of focusing error received from the TTL phase difference type AF apparatus by using the first data when neither the first nor second intermediate adapters is set, correcting the detection result of focusing error received from the TTL phase difference type AF apparatus by using the second data when the first intermediate adapter is set, and correcting the detection result of focusing error received from the TTL phase difference type AF apparatus by using both the second and third data when the second intermediate adapter is set.

14. A camera system according to claim 13, wherein
when second intermediate adapter is set, the camera CPU corrects the second data by using the third data and then the detection result of focusing error received from the TTL phase difference type AF apparatus by using the corrected second data.

15. A camera system according to claim 13, wherein
the camera CPU corrects with any of the first data, the second data, or a combination of the second and third data a difference between the optimum focal point corresponding to the F-number of full open aperture of the interchangeable lens and the optimum focal point corresponding to a F-number of AF sensing aperture of the TTL phase difference type AF apparatus.

16. A camera designed for detachably being set to an interchangeable lens directly or through a first intermediate adapter, comprising:
An AF apparatus which detects a focusing error of the interchangeable lens; and
a camera CPU having a function of reading a first data and second data from the interchangeable lens and a function of correcting the detection result of focusing error received from the AF apparatus by using the first data when the first intermediate adapter is not set, and correcting the detection result of focusing error received from the AF apparatus by using the second data when the first intermediate adapter is set.

17. A camera according to claim 16, wherein
the first data depends on the optical characteristics of only the interchangeable lens, and
the second data depends on the optical characteristics of a combination of the interchangeable lens and the first intermediate adapter.

18. A camera according to claim 16, wherein
the camera CPU has a function of determining whether the first intermediate adapter is set or not.

19. A camera according to claim 18, wherein
the camera CPU determines that the first intermediate adapter is set when its communication with an adapter CPU provided in the first intermediate adapter is enabled.

20. A camera according to claim 16, wherein
the camera CPU corrects with the first or second data a difference between the optimum focal point corresponding to the F-number of full open aperture of the interchangeable lens and the optimum focal point corresponding to a F-number of AF sensing aperture of the AF apparatus.

21. A camera according to claim 16, wherein the first intermediate adapter is replaced by a second intermediate adapter detachably, and the second intermediate adapter is provided for saving third data to correct the second data.

22. A camera according to claim 21, wherein
the camera CPU
corrects the detection result of focusing error received from the AF apparatus by using the first data when neither the first nor second intermediate adapters is set;
corrects the detection result of focusing error received from the AF apparatus by using the second data when the first intermediate adapter is set; and
corrects the detection result of focusing error received from the AF apparatus by using both the second and third data when the second intermediate adapter is set.

23. A camera according to claim 22, wherein
the camera CPU is arranged for communicating with an adapter CPU provided in each of the first and second intermediate adapters and determining from the communication which of the first intermediate adapter and the second intermediate adapter is set.

24. An interchangeable lens designed for detachably being set to a camera body directly or through an intermediate adapter, comprising:
a data storage unit which stores first data that depends on the optical characteristics of only the interchangeable lens and second data that depends on the optical characteristics of a combination of the interchangeable lens and the intermediate adapter, the two data provided as a data to correct an output of an AF apparatus installed in the camera body; and
a lens CPU which transmits the first data and the second data stored in the data storage unit to a camera CPU installed in the camera body.

25. A camera system comprising a camera body and an interchangeable lens detachably set to the camera body, comprising:
a distance measuring part configured to measure a focusing error of the interchangeable lens through detecting a flux of light passed through the interchangeable lens;
an intermediate adapter arranged for detachably being set between the camera body and the interchangeable lens;
a data storing part configured to store first data and second data;
a reading part configured to read the first data and the second data from the data storing part; and
a correcting part configured to correct the detection result of focusing error received from the distance measuring part by using the first data when the intermediate adapter is not set, and correct the detection result of focusing error received from the distance measuring part by using the second data when the intermediate adapter is set.

26. A camera system according to claim 25, wherein
the camera body has a determining part configured to determine whether the intermediate adapter is set or not.

27. A camera system according to claim 25, wherein
the data storing part is installed in the interchangeable lens, and
the correcting part is installed in the camera body.

28. A second intermediate adapter which is applicable to a camera system according to claim 25, and replaces the first intermediate adapter, wherein
the second intermediate adapter has an adapter storing part configured to store third data to correct the second data and a transmitting part configured to transmit the third data to the correcting part.

29. A camera system comprising a camera body and an interchangeable lens detachably set to the camera body, the camera system comprising:
a distance measuring part configured to measure a focusing error of the interchangeable lens through detecting a flux of light passed through the interchangeable lens;
a first intermediate adapter and a second intermediate adapter arranged for detachably being set between the camera body and the interchangeable lens;
a first storing part configured to store first data decided by the optical characteristics of the interchangeable lens and second data decided by the optical characteristics of a combination of the interchangeable lens and the first intermediate adapter;
a second storing part configured to store third data to correct the second data; and
a correcting part configured to correct the output received from the distance measuring part by using the first data when neither the first nor second intermediate adapters is set, correct the output received from the distance measuring part by using the second data when the first intermediate adapter is set, and correct the output received from the distance measuring part by using both the second and third data when the second intermediate adapter is set.

30. A camera system according to claim 29, wherein
the correcting part corrects the second data by using the third data when the second intermediate adapter is set and then corrects the output of the distance measuring part by using the corrected second data.

31. A camera system according to claim 29, wherein
the first data storing part is installed in the interchangeable lens,
the second data storing part is installed in the second intermediate adapter, and
the correcting part is installed in the camera body.

32. A camera designed for detachably being set to an interchangeable lens directly or through an intermediate adapter, comprising:
a distance measuring part configured to measure a focusing error of the interchangeable lens through detecting a flux of light passed through the interchangeable lens;
a reading part configured to read first data and second data from the interchangeable lens; and
a correcting part configured to correct the output of the distance measuring part by using the first data when the intermediate adapter is not set, and correct the output of the distance measuring part by using the second data when the intermediate adapter is set.

33. A camera according to claim 32, wherein
the first data depends on the optical characteristics of only the interchangeable lens, and
the second data depends on the optical characteristics of a combination of the interchangeable lens and the intermediate adapter.

34. A camera according to claim 32, wherein
the camera has a determining part configured to determine whether the intermediate adapter is set or not.
